(19) United States
(12) Patent Application Publication
(10) Pub. No.: US 2019/0181666 A1
(43) Pub. Date: Jun. 13, 2019

(54) CHARGING STATION THAT HOUSES AND CHARGES A ROBOT

(71) Applicant: GROOVE X, Inc., Tokyo (JP)

(72) Inventor: Kaname HAYASHI, Tokyo (JP)

(21) Appl. No.: 16/281,096

(22) Filed: Feb. 21, 2019

Related U.S. Application Data
(63) Continuation of application No. PCT/JP2017/032977, filed on Sep. 13, 2017.

(30) Foreign Application Priority Data
Sep. 16, 2016 (JP) 2016-181513

(51) Int. Cl. H02J 7/00; A63H 11/00; G05D 1/02; A63H 29/22; B25J 19/02; B25J 19/00; B25J 9/00

(52) U.S. Cl. CPC H02J 7/0045; A63H 11/00; G05D 1/0225; A63H 29/22; A63H 2200/00; B25J 19/005; B25J 9/0003; G05D 1/0234; G05D 2201/0214; B25J 19/02

(57) ABSTRACT

A station includes a table upon which a robot rides, a frame disposed so as to enclose a perimeter of the table, a charging unit that charges the robot on the table, a movement mechanism for causing the frame to move along the perimeter of the table, and a movement control unit that controls the movement mechanism. The station may include a reference value providing unit that provides a detection target of an incorporated sensor for an operation of calibrating the sensor by the robot, and outputs a signal indicating a correct detected value of the detection target.

### RELATED APPLICATIONS

The present application is a continuation of International Application No. PCT/JP2017/032977, filed Sep. 13, 2017, which claims priority from Japanese Application No. 2016-181513, filed Sep. 16, 2016, the disclosures of which applications are hereby incorporated by reference herein in their entirety.

### BACKGROUND OF THE INVENTION

### Field of the Invention

The present invention relates to a charging station for charging a robot.

### Description of the Background Art

Development of an autonomously acting robot that provides interaction with and solace to a human, such as a humanoid robot or a pet robot, is being carried out. Although this kind of robot operates in accordance with a control program, the robot causes behavior to evolve by autonomously learning based on a peripheral situation, whereby behavior evoking a sense that the robot is alive also materializes.

As this kind of robot also operates on electrical energy, charging is necessary. Therefore, when a remaining amount of charge of the robot decreases, an alarm is output for a user. When the user notices the alarm, the user positions the robot in a dedicated charging station, and waits until charging is completed. Alternatively, technology such that a robot is capable of communication with a charging station, and the robot is led to the station when a remaining amount of charge reaches a reference value or less and caused to charge autonomously, has also been proposed (for example, refer to JP-A-2003-1577).

Although this kind of charging station is designed in accordance with a form and the like of the robot, there is recognition that it is basically sufficient that a charging function is ensured. With regard to this point, the inventor has arrived at a recognition that usefulness is increased by providing the charging station with an additional function for maintaining performance of the robot, or more desirably, by not causing a user to be aware of a charging action itself.

### SUMMARY OF THE INVENTION

The invention, having been completed based on the heretofore described recognition, has a main object of providing technology that increases usefulness of a robot charging station.

One aspect of the invention is a robot charging station. The charging station is a charging station for carrying out charging of a robot, and includes a table upon which the robot rides, a wall member disposed so as to enclose a perimeter of the table, a charging unit that charges the robot on the table, a movement mechanism for causing the wall member to move along the perimeter of the table, and a movement control unit that controls the movement mechanism.

Another aspect of the invention is also a robot charging station. The charging station is a charging station for carrying out charging of a robot, and includes a charging unit that supplies power to the robot, and a reference value providing unit that provides a detection target of an incorporated sensor for an operation of calibrating the sensor by the robot, and outputs a signal indicating a correct detected value of the detection target.

Still another aspect of the invention is also a robot charging station. The charging station is a charging station for carrying out charging of a robot, and includes a table upon which the robot rides, a charging unit that charges the robot on the table, a rotation mechanism for causing the table to rotate, and a rotation control unit that adjusts a rotational position of the table by controlling the rotation mechanism in accordance with a direction of entry of the robot.

According to aspects of the invention, usefulness of a robot charging station can be increased.

### BRIEF DESCRIPTION OF THE DRAWINGS

FIG. 1 is a drawing representing a charging system of a robot according to an embodiment;

FIGS. 2A and 2B are drawings representing an external view of the robot according to the embodiment;

FIG. 3 is a sectional view schematically representing a structure of the robot;

FIG. 4 is a side view representing the structure of the robot centered on a frame;

FIGS. 5A and 5B are drawings representing a configuration of a station;

FIGS. 6A and 6B are drawings representing a configuration of the station;

FIG. 7 is a functional block diagram of a charging system;

FIGS. 8A and 8B are drawings representing a charging control and an accompanying performance control;

FIGS. 9A and 9B are drawings representing a charging control and an accompanying performance control;

FIGS. 10A and 10B are drawings representing a charging control and an accompanying performance control;

FIGS. 11A and 11B are drawings representing a charging control and an accompanying performance control;

FIGS. 12A and 12B are drawings representing a charging control and an accompanying performance control;

FIG. 13 is a flowchart showing an example of an operation control of the station; and

FIGS. 14A and 14B are drawings representing a configuration of a station according to a modified example.

### DETAILED DESCRIPTION OF THE INVENTION

Hereafter, referring to the drawings, an embodiment of the invention will be described in detail. In the following description, for the sake of convenience, a positional relationship of each structure may be expressed with a state shown in the drawings as a reference. Also, the same reference signs will be allotted to practically identical components in the following embodiment and modified examples thereof, and a description thereof may be omitted as appropriate.

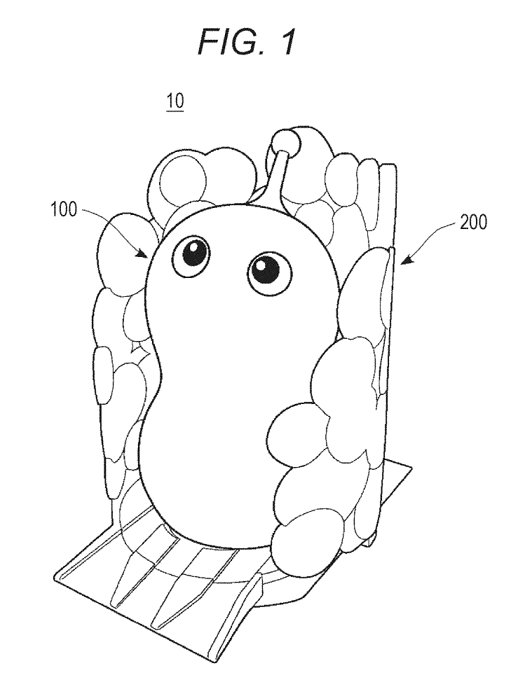

FIG. 1 is a drawing representing a charging system 10 of a robot 100 according to the embodiment. A state wherein the robot 100 is housed in a charging station (hereafter called simply “station”) 200 is shown in the drawing. The station 200 has an internal space in which only one robot 100 can be housed. Charging is started by the robot 100 entering the station 200 and adopting a predetermined posture. Details of a configuration and an operation of each of the robot 100 and the station 200 will be described hereafter.

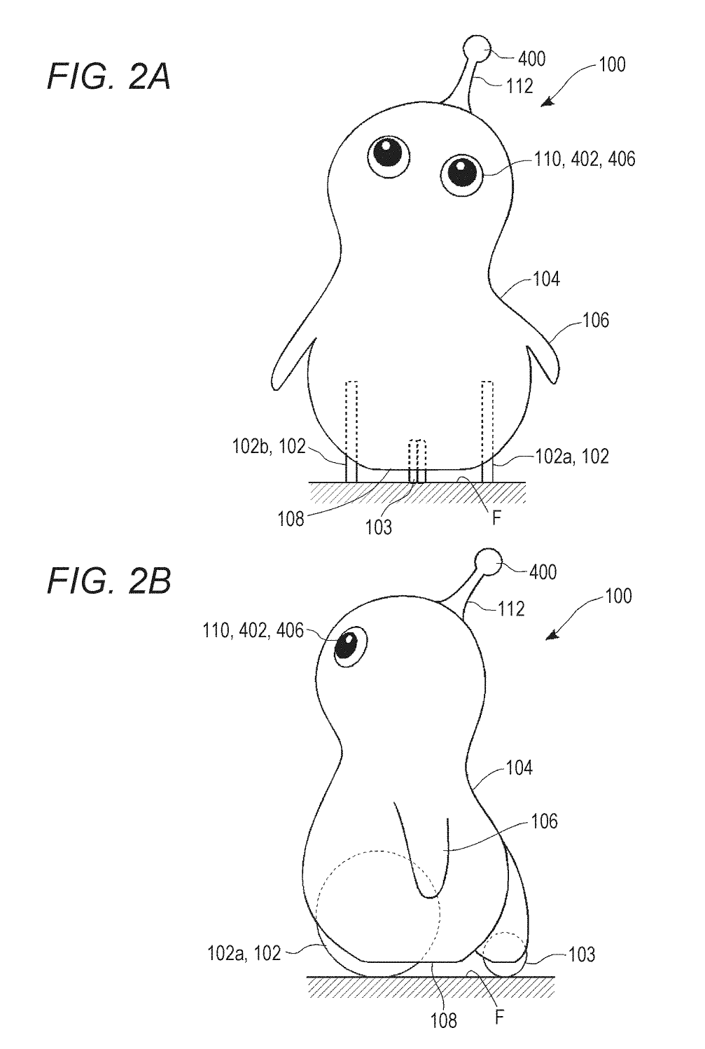

FIGS. 2A and 2B are drawings representing an external view of the robot 100 according to the embodiment. FIG. 2A is a front view, and FIG. 2B is a side view.

The robot 100 is an autonomously acting robot that determines an action or a gesture based on an external environment and an internal state. The external environment is recognized using various kinds of sensor, such as a camera or a thermosensor. The internal state is quantified as various parameters that express emotions of the robot 100.

The robot 100 includes three wheels for three-wheeled traveling. As shown in the drawing, the robot 100 includes a pair of front wheels 102 (a left wheel 102a and a right wheel 102b) and one rear wheel 103. The front wheels 102 are drive wheels, and the rear wheel 103 is a driven wheel. Although the front wheels 102 have no steering mechanism, rotational speed and a direction of rotation can be individually controlled. The rear wheel 103 is formed of a so-called omni wheel, and rotates freely in order to cause the robot 100 to move forward and back, and left and right. By controlling so that the rotational speed of the right wheel 102b is greater than that of the left wheel 102a, the robot 100 can turn left or rotate counterclockwise. By controlling so that the rotational speed of the left wheel 102a is greater than that of the right wheel 102b, the robot 100 can turn right or rotate clockwise.

The front wheels 102 and the rear wheel 103 can be completely housed in a body 104 using a drive mechanism (a pivoting mechanism and a linking mechanism) to be described hereafter. A greater portion of each wheel is hidden by the body 104 when traveling too, but when each wheel is completely housed in the body 104, the robot 100 is in a state of being unable to move. That is, the body 104 descends, and sits on a floor surface F, in accompaniment to an operation of the wheels being housed. In the sitting state, a flat seating face 108 (a grounding bottom face) formed in a bottom portion of the body 104 comes into contact with the floor surface F.

The robot 100 has two arms 106. The arms 106 do not have a function of gripping an object. The arms 106 are capable of performing simple actions such as raising, waving, and oscillating. The two arms 106 can also be individually controlled.

Two eyes 110 are provided in a head portion front surface (a face) of the robot 100. A high resolution camera 402 and a temperature sensor 406 are incorporated at the back of the eye 110. The eye 110 is also capable of an image display using a liquid crystal element or an organic EL element. The robot 100 incorporates a speaker, and is also capable of simple speech. A horn 112 is attached to an apex portion of the robot 100.

An omnidirectional camera 400 (a first camera) is incorporated in the horn 112 of the robot 100. The omnidirectional camera 400 can film in all directions up and down and left and right (360 degrees: in particular, practically all regions above the robot 100) at one time using a fisheye lens. The high resolution camera 402 (a second camera) incorporated in the eye 110 can film only in a direction in front of the robot 100. A filming range of the omnidirectional camera 400 is wide, but resolution is lower than that of the high resolution camera 402.

The temperature sensor 406 may be a thermal imaging camera that converts a peripheral temperature distribution into an image. In addition to this, the robot 100 incorporates various sensors, such as a microphone array having a multiple of microphones, a form measuring sensor (depth sensor) that can measure a form of a measurement target, and an ultrasonic wave sensor.

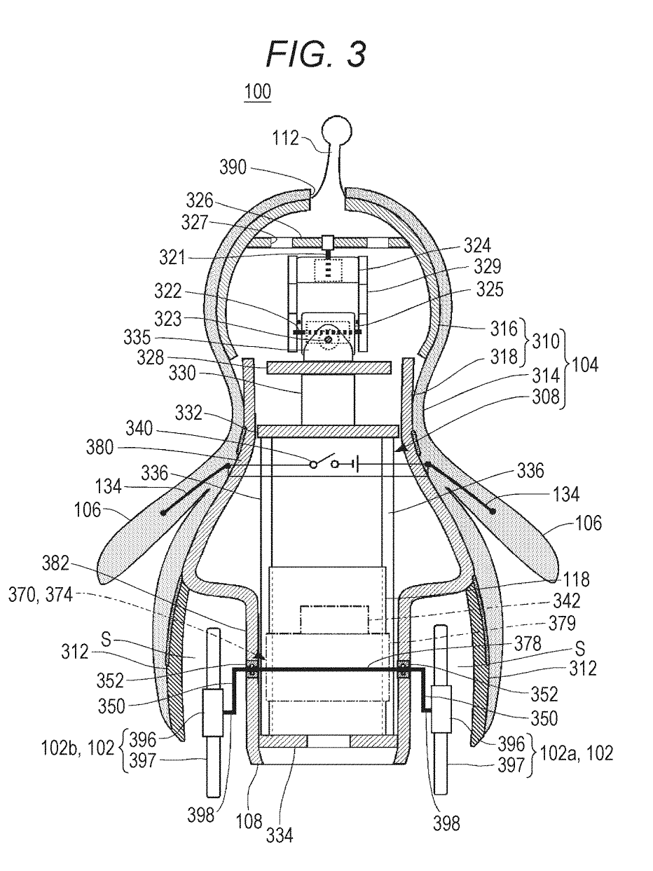

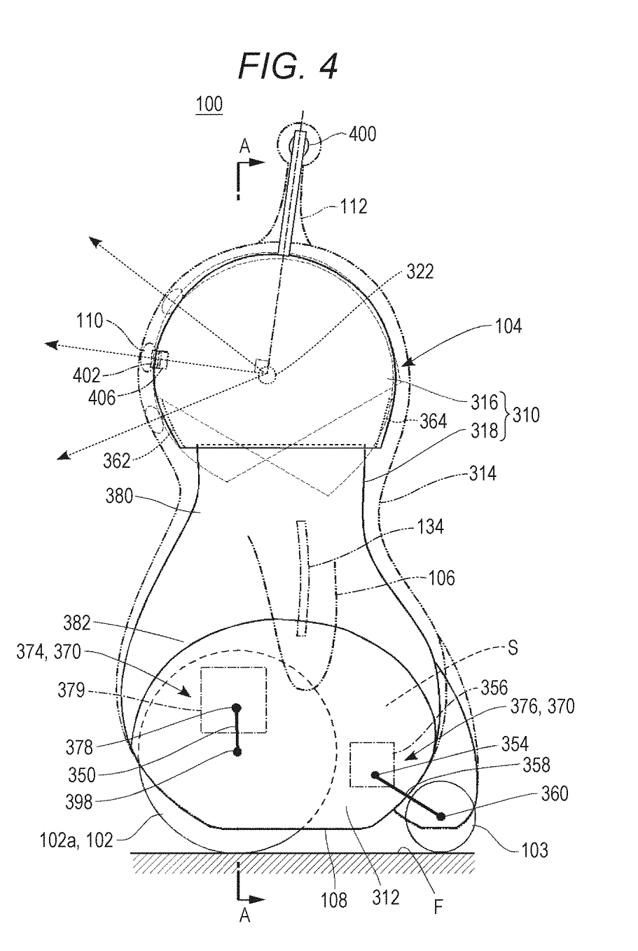

FIG. 3 is a sectional view schematically representing a structure of the robot 100. FIG. 4 is a side view representing the structure of the robot 100 centered on a frame. FIG. 3 corresponds to a section seen along an A-A arrow of FIG. 4.

As shown in FIG. 3, the body 104 of the robot 100 includes a base frame 308, a main body frame 310, a pair of wheel covers 312, and an outer skin 314. The base frame 308 is formed of metal, and supports an internal mechanism together with configuring a shaft of the body 104. The base frame 308 is configured by an upper plate 332 and a lower plate 334 being linked vertically by a multiple of side plates 336. A sufficient interval is provided between the multiple of side plates 336 so that ventilation can be carried out. A battery 118, a control circuit 342, and various kinds of actuator and the like are housed inside the base frame 308.

The main body frame 310 is formed of a resin material, and includes a head portion frame 316 and a trunk portion frame 318. The head portion frame 316 is of a hollow hemispherical form, and forms a head portion framework of the robot 100. The trunk portion frame 318 is of a stepped cylindrical form, and forms a trunk portion framework of the robot 100. The trunk portion frame 318 is integrally fixed to the base frame 308. The head portion frame 316 is attached to an upper end portion of the trunk portion frame 318 so as to be relatively displaceable.

Three shafts, those being a yaw shaft 321, a pitch shaft 322, and a roll shaft 323, and actuators 324 and 325 that drive each shaft so as to rotate, are provided in the head portion frame 316. The actuator 324 includes a servo motor for driving the yaw shaft 321. The actuator 325 includes a multiple of servo motors for driving each of the pitch shaft 322 and the roll shaft 323. The yaw shaft 321 is driven for a head shaking action, the pitch shaft 322 is driven for a nodding action, a looking up action, and a looking down action, and the roll shaft 323 is driven for a head tilting action.

A plate 326 supported by the yaw shaft 321 is fixed to an upper portion of the head portion frame 316. A multiple of ventilation holes 327 for securing ventilation between upper and lower portions are formed in the plate 326.

A base plate 328 made of metal is provided so as to support the head portion frame 316 and an internal mechanism thereof from below. The base plate 328 is linked to the upper plate 332 (the base frame 308) via a joint 330. A support base 335 is provided on the base plate 328, and the actuators 324 and 325 and a crosslink mechanism 329 (a pantagraph mechanism) are supported by the support base 335. The crosslink mechanism 329 links the actuators 324 and 325 vertically, and can cause an interval between the actuators 324 and 325 to change.

More specifically, the roll shaft 323 of the actuator 325 is linked to the support base 335 via a gear mechanism omitted from the drawings. The pitch shaft 322 of the actuator 325 is linked to a lower end portion of the crosslink mechanism 329. Meanwhile, the actuator 324 is fixed to an upper end portion of the crosslink mechanism 329. The yaw shaft 321 of the actuator 324 is linked to the plate 326. A rotary drive mechanism, omitted from the drawings, for driving the crosslink mechanism 329 so as to extend and contract is provided in the actuator 325.

According to this kind of configuration, the actuator 325 and the head portion frame 316 can be caused to rotate (roll) integrally by causing the roll shaft 323 to rotate, whereby an action of tilting the head can be realized. Also, the crosslink mechanism 329 and the head portion frame 316 can be caused to rotate (pitch) integrally by causing the pitch shaft 322 to rotate, whereby a nodding action and the like can be realized. The plate 326 and the head portion frame 316 can be caused to rotate (yaw) integrally by causing the yaw shaft 321 to rotate, whereby an action of shaking the head can be realized. Furthermore, an action of extending and contracting the neck can be realized by causing the crosslink mechanism 329 to extend and contract.

The trunk portion frame 318 houses the base frame 308 and a wheel drive mechanism 370. As shown in FIG. 4, the wheel drive mechanism 370 includes a front wheel drive mechanism 374 and a rear wheel drive mechanism 376. An upper half portion 380 of the trunk portion frame 318 is of a smooth curved form so as to provide an outline of the body 104 with roundness. The upper half portion 380 is formed so as to become gradually narrower toward an upper portion corresponding to a neck portion. A lower half portion 382 of the trunk portion frame 318 is of a small width in order to form a housing space S of the front wheel 102 between the wheel covers 312. A boundary of the upper half portion 380 and the lower half portion 382 is of a stepped form.

Left and right side walls configuring the lower half portion 382 are parallel to each other, are penetrated by a pivot shaft 378, to be described hereafter, of the front wheel drive mechanism 374, and support the pivot shaft 378. The lower plate 334 is provided so as to close off a lower end aperture portion of the lower half portion 382. In other words, the base frame 308 is fixed to and supported by a lower end portion of the trunk portion frame 318.

The pair of wheel covers 312 are provided so as to cover the lower half portion 382 of the trunk portion frame 318 from left and right. The wheel cover 312 is formed of resin, and is attached so as to form a smooth outer face (curved face) continuous with the upper half portion 380 of the trunk portion frame 318. An upper end portion of the wheel cover 312 is linked along a lower end portion of the upper half portion 380. Because of this, the housing space S, which is opened downward, is formed between the side wall of the lower half portion 382 and the wheel cover 312.

The outer skin 314 is formed of urethane rubber, and covers the main body frame 310 and the wheel covers 312 from an outer side. The arms 106 are molded integrally with the outer skin 314. An aperture portion 390 for introducing external air is provided in an upper end portion of the outer skin 314.

The front wheel drive mechanism 374 includes a rotary drive mechanism for causing the front wheel 102 to rotate and a housing operation mechanism for causing the front wheel 102 to enter and withdraw from the housing space S. That is, the front wheel drive mechanism 374 includes the pivot shaft 378 and an actuator 379. The front wheel 102 has a direct drive motor (hereafter written as a “DD motor”) 396 in a central portion thereof. The DD motor 396 has an outer rotor structure, a stator is fixed to an axle 398, and a rotor is fixed coaxially to a rim 397 of the front wheel 102. The axle 398 is integrated with the pivot shaft 378 via an arm 350. A bearing 352 through which the pivot shaft 378 penetrates and which supports the pivot shaft 378 so as to be able to pivot is embedded in a lower portion side wall of the trunk portion frame 318. A sealing structure (bearing seal) for hermetically sealing the trunk portion frame 318 inside and outside is provided in the bearing 352. The front wheel 102 can be driven to reciprocate between the housing space S and an exterior by a drive of the actuator 379.

The rear wheel drive mechanism 376 includes a pivot shaft 354 and an actuator 356. Two arms 358 extend from the pivot shaft 354, and an axle 360 is provided integrally with leading ends of the arms 358. The rear wheel 103 is supported so as to be able to rotate by the axle 360. A bearing omitted from the drawings, through which the pivot shaft 354 penetrates and which supports the pivot shaft 354 so as to be able to pivot, is embedded in the lower portion side wall of the trunk portion frame 318. A shaft sealing structure is also provided in the bearing. The rear wheel 103 can be driven to reciprocate between the housing space S and the exterior by a drive of the actuator 356.

When housing the wheels, the actuators 379 and 356 are driven in one direction. At this time, the arm 350 pivots centered on the pivot shaft 378, and the front wheel 102 rises from the floor surface F. Also, the arm 358 pivots centered on the pivot shaft 354, and the rear wheel 103 rises from the floor surface F. Because of this, the body 104 descends, and the seating face 108 is grounded at the floor surface F. Because of this, a state in which the robot 100 is sitting is realized. By the actuators 379 and 356 being driven in the opposite direction, each wheel is caused to advance out of the housing space S, whereby the robot 100 can be caused to stand.

A drive mechanism for driving the arm 106 includes a wire 134 embedded in the outer skin 314, and a drive circuit 340 (energizing circuit) of the wire 134. The wire 134 is formed of a shape memory alloy line in this embodiment, contracts and hardens when heated, and relaxes and lengthens when allowed to cool. Leads drawn out from both ends of the wire 134 are connected to the drive circuit 340. When a switch of the drive circuit 340 is activated, the wire 134 (shape memory alloy line) is energized.

The wire 134 is molded or woven in so as to extend from the outer skin 314 to the arm 106. Leads are drawn from both ends of the wire 134 into the trunk portion frame 318. One wire 134 may be provided in each of a left and right of the outer skin 314, or a multiple of the wire 134 may be provided in parallel in each of the left and right of the outer skin 314. The arm 106 can be raised by energizing the wire 134, and the arm 106 can be lowered by interrupting the energization.

An angle of a line of sight (refer to dotted arrows) of the robot 100 can be adjusted by controlling an angle of rotation of the pitch shaft 322. In the embodiment, for the sake of convenience, a direction of an imaginary straight line passing through the pitch shaft 322 and the eye 110 is taken to be a direction of the line of sight. An optical axis of the high resolution camera 402 coincides with the line of sight. Also, in order to facilitate a computing process, a straight line joining the omnidirectional camera 400 and pitch shaft 322 and the line of sight are set so as to form a right angle.

Slits 362 and 364 through which the upper end portion of the trunk portion frame 318 can be inserted are provided at the front and back of the head portion frame 316. Because of this, a range of movement (range of rotation) of the head portion frame 316, which is centered on the pitch shaft 322, can be increased. In the embodiment, the range of movement is taken to be 90 degrees, which is 45 degrees each up and down from a state wherein the line of sight is horizontal. That is, a limit value of an angle at which the line of sight of the robot 100 is oriented upward (an angle of looking up) is taken to be 45 degrees, and a limit value of an angle at which the line of sight is oriented downward (an angle of looking down) is also taken to be 45 degrees.

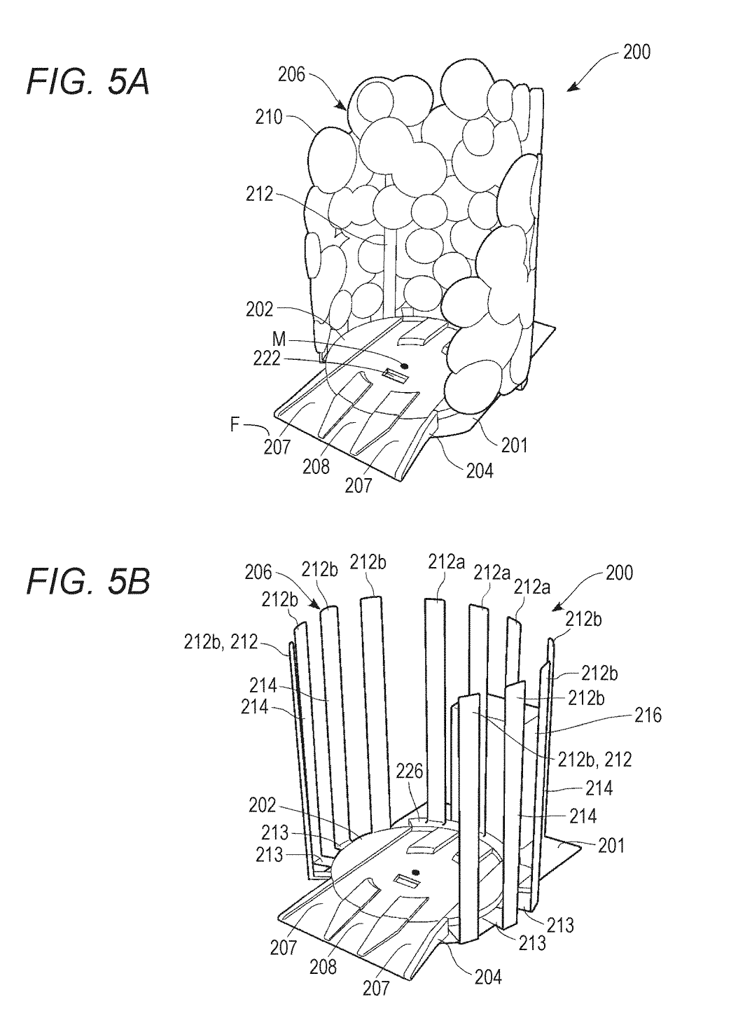

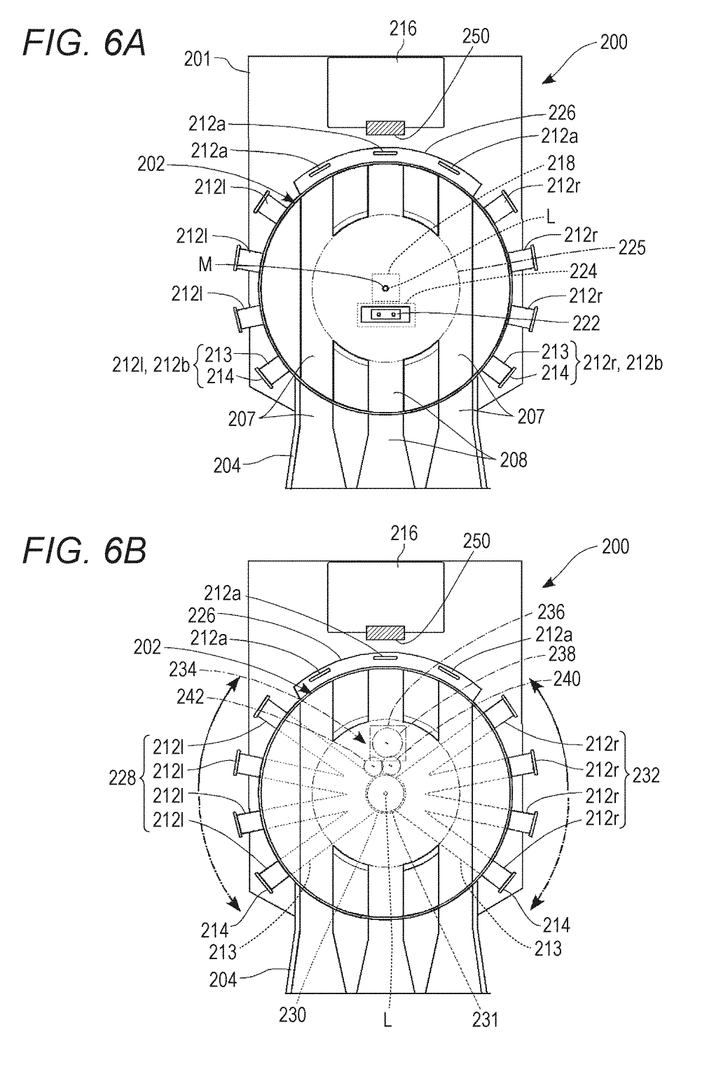

FIGS. 5A to 6B are drawings representing a configuration of the station 200. FIG. 5A is a perspective view representing an external appearance, and FIG. 5B is a perspective view representing a state wherein a decoration has been removed. FIG. 6A is a plan view representing the state wherein the decoration has been removed, and FIG. 6B is an illustration representing a drive mechanism.

As shown in FIG. 5A, the station 200 includes a base 201, a table 202 supported by the base 201, a slope 204 that forms a smooth bridge between an upper surface of the table 202 and the floor surface F, and a frame 206 provided on a perimeter of the table 202. The table 202 is a circular turntable supported so as to be able to rotate by the base 201. Guide grooves 207 and 208 for guiding the front wheel 102 and the rear wheel 103 of the robot 100 in a direction of travel are formed in upper surfaces of the table 202 and the slope 204. A mark M (target point) that is used as a guide when the robot 100 enters the station 200 is applied to a center of the table 202. In the embodiment, the mark M is a circular region of a color differing from that of the table 202. In another aspect, as it is sufficient that the mark M is formed so as to be recognized as the mark M by the robot 100 using image processing, the surface may be ground in a circular shape, or the mark M may be formed of an LED, a reflective plate, or the like.

The frame 206 includes a decorative member 210 that encloses the perimeter of the table 202. The decorative member 210 of the embodiment is obtained by a large number of decorative pieces with a tree leaf as a motif being placed one on another, and creates an image of a hedge. A side on which the slope 204 is positioned in the station 200 is a gate (front), and is opened so as to be able to accept the robot 100.

As also shown in FIG. 5B, the frame 206 includes a multiple of support columns 212 that enclose the perimeter of the table 202 in an annular form. The support column 212 functions as a “wall member” together with the decorative member 210. Looking from the front of the station 200, three support columns 212a are disposed at the back, and four support columns 212b are disposed on each of the left and right. The support column 212a is formed of a plate extending upward, and a lower end thereof is fixed to the base 201. Meanwhile, the support column 212b is formed of an L-form plate, and has a support portion 213 that extends in a radial direction below the table 202, and a column portion 214 that extends upward on an outer side of the table 202. The decorative member 210 is placed over the support columns 212, whereby a hedge shown in FIG. 5A is represented.

A control device 216 for controlling the station 200 is provided behind (on a side opposite that of the slope 204) the frame 206. The control device 216 is connected to a domestic power supply via an unshown adapter.

As shown in FIG. 6A, the table 202 is supported so as to be able to rotate in an approximate center of the base 201. A rotation mechanism 218 for causing the table 202 to rotate is provided below the table 202. The table 202 has a rotary shaft on a central shaft L thereof, and when an angle of rotation of the table 202 reaches a predetermined angle shown in the drawing, the guide grooves 207 and 208 are caused to be continuous between the table 202 and the slope 204. A seating face 225 on which the robot 100 is caused to sit is formed in the center of the table 202 (refer to a two-dot chain line). The seating face 225 has a circular form centered on the central shaft L. A height of the seating face 225 is equal to a height of the guide grooves 207 and 208.

A power supply connection terminal 222 is provided in a position slightly offset from the central shaft L in the table 202. The connection terminal 222 is driven to advance and withdraw, so as to appear from and disappear into the upper surface of the table 202, by a connection mechanism 224 provided below the table 202. The mark M is applied on the central shaft L in the center of the upper surface of the table 202. The mark M is positioned on a straight line passing through the central shaft L and a center of the connection terminal 222 on the table 202. In a modified example, the mark M may be provided in a position on the straight line differing from that of the central shaft L.

A pedestal 226 of an arc form when seen in plan view is provided behind the table 202, and fixed to the base 201. The three support columns 212a are disposed erect at equal intervals on the pedestal 226. The eight support columns 212b, including four support columns 2121 on the left side and four support columns 212r on the right side, can pivot centered on the central shaft L. The column portions 214 of the support columns 212b are positioned on concentric circles centered on the central shaft L, but an inscribed circle thereof is greater than a circumscribed circle of the pedestal 226. One portion of the support columns 212b can rotate to a position behind the support columns 212a.

As shown in FIG. 6B, the four support columns 2121 on the left side are integrated below the table 202, configuring a left support column unit 228. The left support column unit 228 has a rotary shaft on the central shaft L, and a gear 230 is provided coaxially and integrally with the rotary shaft. The four support columns 212r on the right side are also integrated below the table 202, configuring a right support column unit 232. The right support column unit 232 also has a rotary shaft on the central shaft L, and a gear 231 is provided coaxially and integrally with the rotary shaft. The gear 231 and the gear 230 have an equal number of teeth. The rotary shafts of the left support column unit 228 and the right support column unit 232 are cylindrical shafts fitted around the rotary shaft of the table 202, and are provided deviating in an axial direction, because of which the rotary shafts do not interfere with each other.

A movement mechanism 234 for causing each of the left support column unit 228 and the right support column unit 232 to pivot is provided below the table 202. The movement mechanism 234 includes a motor 236 that is a drive source, a first gear 238 connected to a rotary shaft of the motor 236, a second gear 240 connected to the first gear 238, and a third gear 242 connected to the second gear 240. The motor 236 may be a stepping motor or a DC motor. The second gear 240 and the third gear 242 have an equal number of teeth. The gear 230 of the left support column unit 228 is connected to the motor 236 via the third gear 242, the second gear 240, and the first gear 238. The gear 231 of the right support column unit 232 is connected to the motor 236 via the second gear 240 and the first gear 238.

This kind of configuration is such that when the motor 236 is driven in one direction, the left support column unit 228 and the right support column unit 232 pivot in gate opening directions (directions such that an entrance of the station 200 is opened by the wall member; refer to a solid arrow). When the motor 236 is driven in another direction, the left support column unit 228 and the right support column unit 232 pivot in gate closing directions (directions such that the entrance of the station 200 is closed by the wall member; refer to a dotted chain arrow).

A reference value providing unit 250 for calibration is provided in an upper portion of the control device 216. In the embodiment, calibration of the temperature sensor 406 by the robot 100 can be carried out in the station 200. The reference value providing unit 250 has a hot wire whose temperature is adjustable, adjusts the temperature of the hot wire in stages in accordance with a preset calibration program, and outputs a signal indicating a temperature value (correct detected value) of the hot wire. The robot 100 can execute calibration by comparing a value output by the temperature sensor 406 and the temperature value, and correcting a difference between the two.

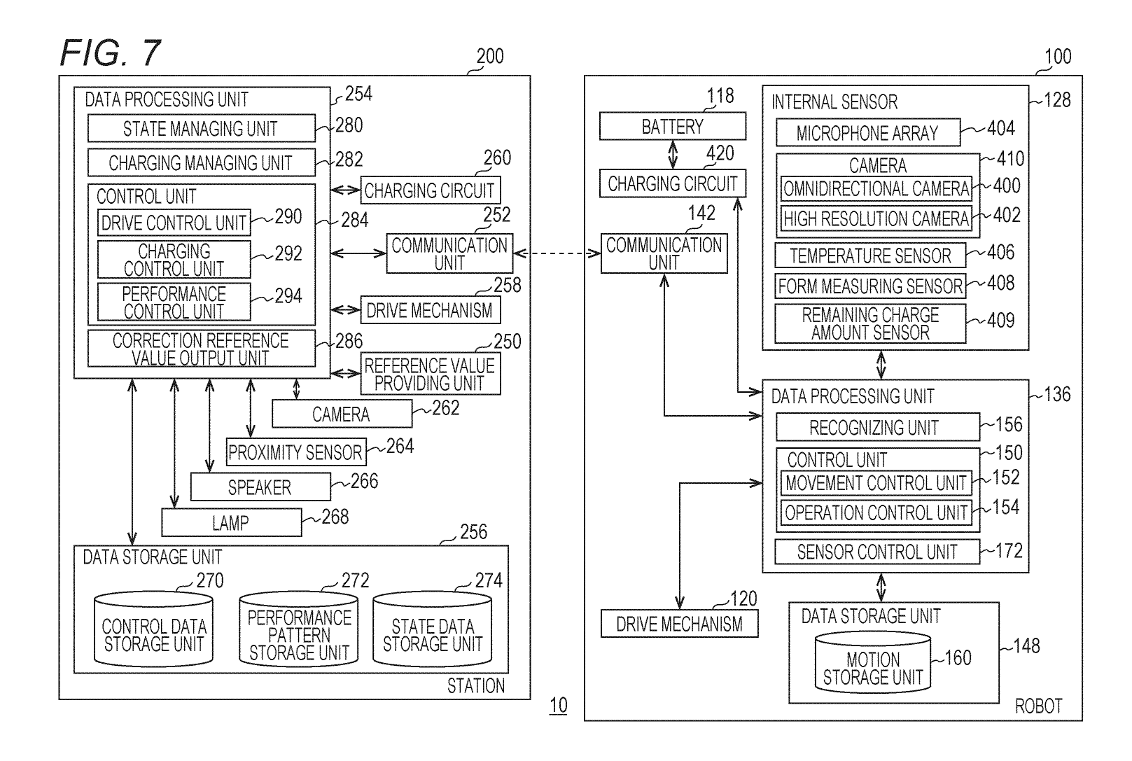

FIG. 7 is a functional block diagram of the charging system 10.

As heretofore described, the charging system 10 includes the robot 100 and the station 200. Each component of the robot 100 and the station 200 is realized by hardware including a computer formed of a CPU (central processing unit), various kinds of coprocessor, and the like, a storage device that is a memory or storage, and a wired or wireless communication line that links the computer and the storage device, and software that is stored in the storage device and supplies a processing command to the computer. A computer program may be configured of a device driver, an operating system, various kinds of application program positioned in an upper layer thereof, and a library that provides a common function to the programs. Each block described hereafter indicates a functional unit block rather than a hardware unit configuration.

The robot 100 includes an internal sensor 128, a communication unit 142, a data processing unit 136, a data storage unit 148, a drive mechanism 120, the battery 118, and a charging circuit 420. The internal sensor 128 is a collection of various kinds of sensor. The internal sensor 128 includes a microphone array 404, a camera 410, the temperature sensor 406, a form measuring sensor 408, and a remaining charge amount sensor 409.

The microphone array 404, being a unit wherein a multiple of microphones are linked together, is a voice sensor that detects sound. It is sufficient that the microphone array 404 is a device that detects sound, and can detect a direction of a source of the sound. The microphone array 404 is incorporated in the head portion frame 316. As distances between a sound source and each microphone do not coincide, variation occurs in sound collection timing. Because of this, a position of the sound source can be identified from a magnitude and a phase of sound at each microphone. The robot 100 can detect a position of a sound source, and in particular a direction of the sound source, using the microphone array 404.

The camera 410 is a device that films the exterior. The camera 410 includes the omnidirectional camera 400 and the high resolution camera 402. The temperature sensor 406 detects a temperature distribution of an external environment, and converts the temperature distribution into an image. In the embodiment, the temperature sensor 406 is provided in the position of the eye 110, but the temperature sensor 406 may be provided in another region, such as a center of the face of the robot 100. The form measuring sensor 408 is an infrared depth sensor that reads a depth, and by extension an uneven form, of a target object by emitting near-infrared rays from a projector, and detecting reflected light of the near-infrared rays using a near-infrared camera.

The communication unit 142 manages a process of communicating with the station 200. The data storage unit 148 is a storage device that stores various kinds of data. The data processing unit 136 executes various kinds of process based on data acquired by the communication unit 142 and data stored in the data storage unit 148. The data processing unit 136 corresponds to a processor and a computer program executed by the processor. The data processing unit 136 also functions as an interface of the communication unit 142, the internal sensor 128, the drive mechanism 120, and the data storage unit 148.

The data storage unit 148 includes a motion storage unit 160 that defines various kinds of motion of the robot 100. Various motions performed by the robot 100 are defined in the motion storage unit 160. A motion is identified by motion ID. An operation timing, an operating time, an operating direction, and the like, of the various kinds of actuator (the drive mechanism 120) are defined chronologically in a motion file in order to perform various motions such as sitting by housing the front wheel 102, raising the arm 106, causing the robot 100 to carry out a rotating action by causing the two front wheels 102 to rotate in reverse or by causing only one front wheel 102 to rotate, shaking by causing the front wheel 102 to rotate in a state in which the front wheel 102 is housed, or stopping once and looking back when moving away from a user. Also, a charging posture adopted after the robot 100 enters the station 200, a performance motion during charging, a performance motion after charging, and the like, are also defined in the data storage unit 148.

The data processing unit 136 includes a recognizing unit 156, a control unit 150, and a sensor control unit 172. The control unit 150 includes a movement control unit 152 and an operation control unit 154. The movement control unit 152 determines a direction of movement of the robot 100. The drive mechanism 120 causes the robot 100 to head toward a movement target point by driving the front wheel 102 in accordance with an instruction from the movement control unit 152.

The operation control unit 154 determines a motion of the robot 100. The operation control unit 154 instructs the drive mechanism 120 to execute a selected motion. The drive mechanism 120 controls each actuator in accordance with the motion file.

The sensor control unit 172 controls the internal sensor 128. Specifically, the sensor control unit 172 controls a direction of measurement by the high resolution camera 402, the temperature sensor 406, and the form measuring sensor 408. The direction of measurement by the high resolution camera 402, the temperature sensor 406, and the form measuring sensor 408 mounted in the head portion of the robot 100 changes in accordance with the orientation of the head portion frame 316. The sensor control unit 172 controls a direction of filming by the high resolution camera 402 (that is, the sensor control unit 172 controls movement of the head portion in accordance with the direction of filming).

The recognizing unit 156 analyzes external information obtained from the internal sensor 128. The recognizing unit 156 is capable of visual recognition (a visual unit), smell recognition (an olfactory unit), sound recognition (an aural unit), and tactile recognition (a tactile unit). The recognizing unit 156 regularly acquires detection information from the camera 410, the temperature sensor 406, and the form measuring sensor 408, and can detect a moving object such as a person or a pet, and a fixed object such as audio equipment or a television. The recognizing unit 156 extracts characteristics (physical characteristics and behavioral characteristics) of the moving object, and can cluster analyze a multiple of moving objects based on the characteristics.

The recognizing unit 156 carries out an approximate image analysis of a subject based on an image filmed by the omnidirectional camera 400. When identifying a user from the subject, the recognizing unit 156 measures the peripheral temperature distribution of the subject using the temperature sensor 406, and determines whether or not the subject is a heat generating body, and in particular, a body generating heat in the region of 30 to 40 degrees Celsius. When the subject is in this temperature range, the recognizing unit 156 can assume that the subject is a homeotherm such as a human or a pet.

The recognizing unit 156 also measures a three-dimensional form of the subject using the form measuring sensor 408, and determines whether or not the subject is an object having a predetermined form. For example, the recognizing unit 156 determines whether or not the subject has an uneven form. When the subject does not have an uneven form, the recognizing unit 156 can assume that the subject is a flat body such as a television, a wall, or a mirror.

When an image that should be filmed is identified in this way by the temperature sensor 406 and the form measuring sensor 408, the filming target is filmed using the high resolution camera 402. At this time, an angle of view is adjusted so that the whole of the filming target is included in a center of a screen. As already mentioned, the optical axis of the high resolution camera 402 coincides with the line of sight. Because of this, the filming target exists in the direction of the line of sight of the robot 100. The recognizing unit 156 cluster analyzes the filming target based on an image filmed by the high resolution camera 402, and selects an operation such as approaching or moving away.

The remaining charge amount sensor 409 detects a remaining amount of charge in the battery 118. When the remaining amount of charge reaches a predetermined value or lower, the data processing unit 136 starts a control process for charging, to be described hereafter, and outputs a charging request signal to the station 200. The movement control unit 152 causes the robot 100 to move to the station 200. The battery 118 can be charged by the charging circuit 420 being connected to a charging circuit of the station 200.

The station 200 includes a communication unit 252, a data processing unit 254, a data storage unit 256, the reference value providing unit 250, a drive mechanism 258, a charging circuit 260, a camera 262, a proximity sensor 264, a speaker 266, and a lamp 268. The communication unit 252 manages a process of communicating with the robot 100. The data storage unit 256 stores various kinds of data. The data processing unit 254 executes various kinds of process based on a signal received via the communication unit 252 and data stored in the data storage unit 256. The data processing unit 254 also functions as an interface of the communication unit 252, the data storage unit 256, the reference value providing unit 250, and the drive mechanism 258.

The reference value providing unit 250 includes a hot wire for heating and a temperature sensor, and when the robot 100 executes a calibration of the temperature sensor 406, the reference value providing unit 250 heats the hot wire, and outputs a signal indicating the temperature value (correct detected value) of the hot wire.

The drive mechanism 258 includes the heretofore described rotation mechanism 218, the movement mechanism 234, and the connection mechanism 224. The charging circuit 260 includes the heretofore described connection terminal 222, to which the charging circuit 420 is connected when charging the robot 100. The camera 262 is provided integrally with the control device 216, and films the internal space and a periphery of the station 200. A filmed image is used for identifying a position of the robot 100 when charging. The proximity sensor 264 is provided in a vicinity of the connection terminal 222 in the table 202, and when the robot 100 sits (houses the wheels), the proximity sensor 264 detects the matter. The speaker 266 and the lamp 268 are used in a charging performance to be described hereafter.

The data storage unit 256 includes a control data storage unit 270, a performance pattern storage unit 272, and a state data storage unit 274. The control data storage unit 270 stores a control program for charging control and performance control.

Multiple kinds of performance pattern executed when charging the robot 100 are defined in the performance pattern storage unit 272. A performance pattern is identified by pattern ID. An operation timing, an operating time, an operating direction, and the like, of the various kinds of mechanism and device are defined chronologically as pattern data in order to express various performance patterns such as lighting up when starting charging of the robot 100, increasing an intensity of a light in order to notify of charging completion, outputting speech, or outputting theme music for sending the robot 100 out together with opening the gate.

The state data storage unit 274 stores and updates an operating state and positional information of the robot 100 obtained by communication or filming, a current operating state of the station 200, and the like.

The data processing unit 254 includes a state managing unit 280, a charging managing unit 282, a control unit 284, and a correction reference value output unit 286. The state managing unit 280 manages the current operating state of the station 200. The charging managing unit 282 manages a charging state of the robot 100 (including whether or not charging is in progress, a charge ratio, and the like). When charging is completed, the robot 100 outputs a charging completion signal indicating the matter. The charging managing unit 282 determines that charging is completed based on receiving the charging completion signal.

The control unit 284 includes a drive control unit 290, a charging control unit 292, and a performance control unit 294. The drive control unit 290 controls the drive mechanism 258 (the rotation mechanism 218, the connection mechanism 224, and the movement mechanism 234), and also functions as a “rotation control unit” and a “movement control unit”. The charging control unit 292 controls the charging circuit 260 based on the charging state managed by the charging managing unit 282. The performance control unit 294 decides on a performance pattern when starting charging, and executes a control such as a drive, a lighting up, or a speech output of each mechanism in accordance with the performance pattern.

When the robot 100 enters the station 200, or when there has been a calibration execution request from the robot 100, the correction reference value output unit 286 adjusts the temperature of the hot wire in stages, and outputs a signal indicating the temperature value (the correct detected value, hereafter also called a “correction reference value”) of the hot wire, as heretofore described. The robot 100 executes calibration by comparing a value detected by the temperature sensor 406 and the temperature value, and correcting a difference between the two.

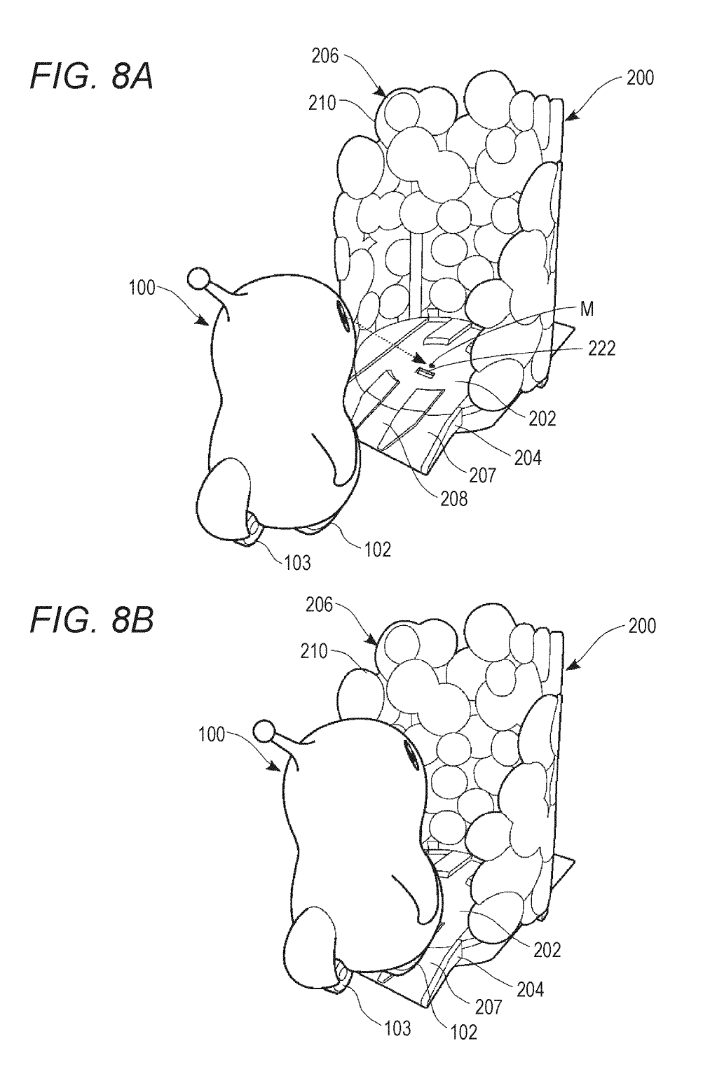

FIGS. 8A to 12B are drawings representing a charging control and an accompanying performance control. A and B of each drawing show an example of a control process.

When the remaining amount of charge in the battery 118 reaches a predetermined value or lower, the robot 100 outputs a charging request signal to the station 200. The station 200 receives the charging request signal, starts wireless communication with the robot 100, and outputs a guiding signal (for example, an infrared beam). The robot 100 can enter the station 200 by moving with reliance on the guiding signal.

The robot 100 films the mark M when entering the station 200, and with the mark M as a guide, controls a direction of travel of the robot 100 so as to be positioned on a straight line joining the mark M and the connection terminal 222. By so doing, the robot 100 can ride up onto the center of the table 202 along the guide grooves 207 and 208, and can cause positions and directions of a connection terminal of the robot 100 and the connection terminal 222 to coincide. As the robot 100 has the heretofore described omni wheel, the robot 100 can rotate freely on the spot, because of which the direction of travel can be adjusted easily, even immediately before the station 200. That is, there is no need to withdraw once and change an orientation before the station 200, change direction several times, or the like, and the robot 100 can enter the table 202 smoothly.

As shown in FIGS. 8A and 8B, the robot 100 rides up onto the slope 204 with the front wheel 102 leading, and advances to the table 202. At this time, the robot 100 travels so that the left and right front wheels 102 advance along the left and right guide grooves 207, and the rear wheel 103 advances along the central guide groove 208. When the robot 100 advances up the slope 204 in this way, the actuator 356 (refer to FIG. 4) of the rear wheel 103 can adjust the angle of the arm 358 by an appropriate amount, whereby the robot 100 can climb the slope 204 stably and smoothly.

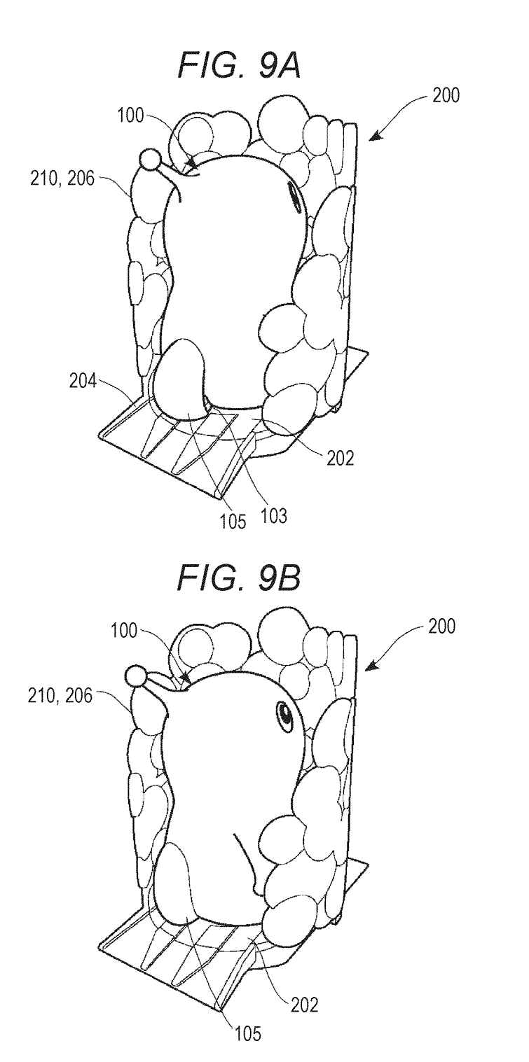

When the robot 100 reaches a predetermined position (the center) on the table 202 in accordance with the guiding signal, the robot 100 sits by housing the wheels, as shown in FIG. 9A. At this time, a tail 105 is closed after the rear wheel 103 is housed. The tail 105 functions as a cover member that closes an entrance of the rear wheel 103. When the proximity sensor 264 detects the sitting of the robot 100, the connection mechanism 224 causes the connection terminal 222 to advance. The connection terminal 222 is connected to a connection terminal provided in a bottom portion of the robot 100. Because of this, the charging circuits of the robot 100 and the station 200 attain a conductive state.

When stopping in the direction of entering, as shown in the drawings, the robot 100 outputs a calibration request. The correction reference value output unit 286 receives the calibration request, and causes the reference value providing unit 250 to operate, thereby providing a correction reference value. The robot 100 detects the temperature of the reference value providing unit 250 using the temperature sensor 406, and executes a calibration by comparing the detected value and the correction reference value.

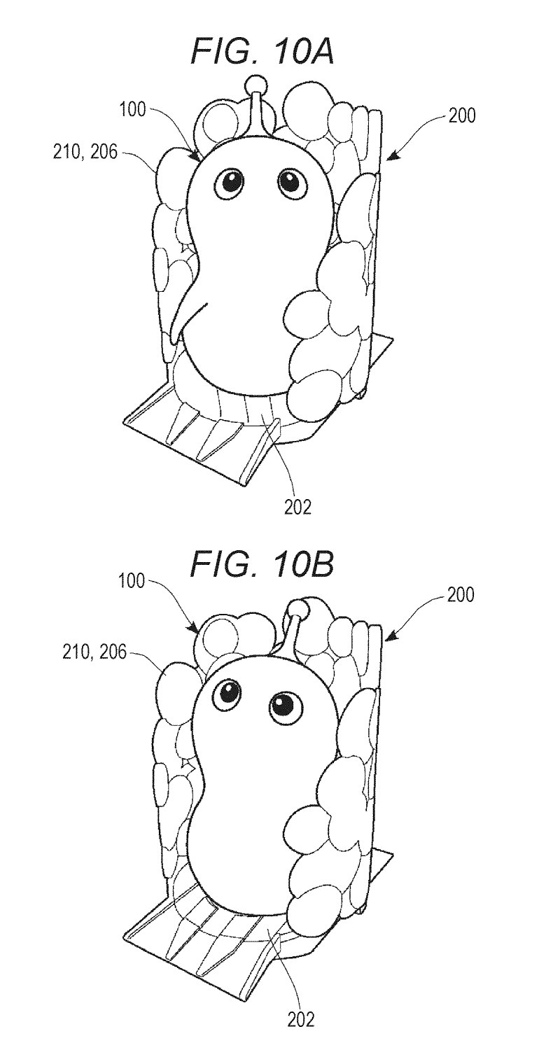

Continuing, the drive control unit 290 drives the rotation mechanism 218, causing the table 202 to rotate, as shown in FIG. 9B. When an angle of rotation is such that the robot 100 faces the front (180 degrees from the start of rotation), as shown in FIGS. 10A and 10B, the drive control unit 290 causes the rotation mechanism 218 to stop. As the frame 206 has a height equal to that of the robot 100, the face of the robot 100 can be confirmed from the exterior by the robot 100 facing the front in this way.

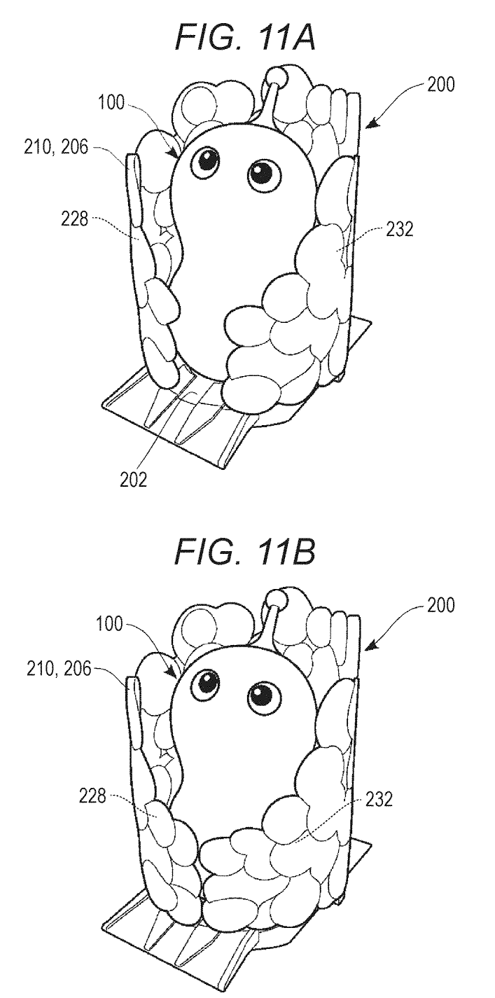

Continuing, the drive control unit 290 drives the movement mechanism 234, thereby causing the left support column unit 228 and the right support column unit 232 to move forward, as shown in FIG. 11A. Because of this, the hedge-aspect decorative member 210 takes on an aspect of enclosing the whole of a periphery of the robot 100, as shown in FIG. 11B. Note that as a height of the decorative member 210 is reduced in a vicinity of the front, an open space is formed in a front upper portion even in a state in which the hedge is closed in this way, and the face of the robot 100 can be exposed. The charging control unit 292 starts a charging control in a state wherein the robot 100 faces the front in this way. According to this kind of configuration and control, a performance such that it seems exactly as though the robot 100 is recovering energy by returning to its own nest can be carried out.

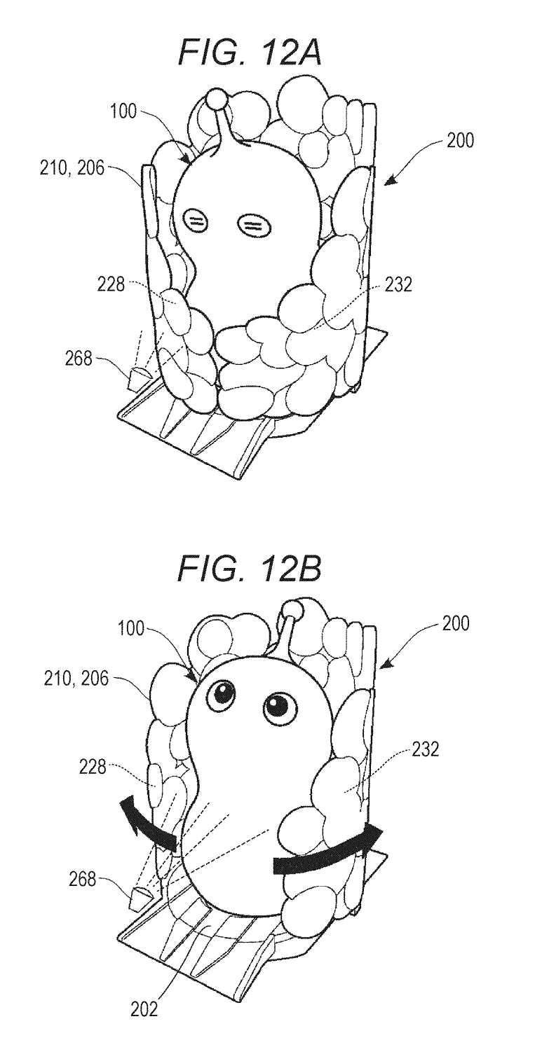

In the embodiment, a unique performance is carried out while the robot 100 is being charged. That is, the robot 100 performs a gesture of lowering the head portion and resting or sleeping, as shown in FIG. 12A. At this time, the robot 100 carries out a performance of expressing respiration by raising and lowering the arm 106 to an appropriate extent, and making a noise as though asleep. The performance control unit 294 lights up the robot 100 by turning the lamp 268 on low. By reducing illuminance, an appearance of the robot 100 resting peacefully (an appearance of relaxing) can be portrayed. At this time, soothing music may be played simultaneously. Hereafter, this kind of performance during charging will also be called a “performance during charging”.

During the charging, the robot 100 lowers a brightness of the eye 110. Particularly when the eye 110 is configured of an organic EL element, there is a high possibility of advancing deterioration when continuing a state wherein brightness is high. Therefore, the brightness is reduced in accordance with expressing rest during charging. There is no sense of incongruity to this either in terms of causing the robot 100 to emulate animal-like behavior. Also, by adopting a state in which the head is lowered, the robot 100 can also be rendered inconspicuous.

When charging is completed, the performance control unit 294 raises the illuminance of the lamp 268, and outputs theme music for sending out the robot 100 from the speaker 266. By the theme music being such as to cause an impression of vitality, an aspect of the robot 100 recovering energy by resting can be portrayed. Hereafter, this kind of performance after charging is completed will also be called a “charging completed performance”.

Together with starting this kind of performance, the drive control unit 290 causes the left support column unit 228 and the right support column unit 232 to move backward by driving the movement mechanism 234. By so doing, the gate is opened, and the robot 100 can be sent out. After confirming that the gate is opened, the robot 100 stands up by releasing the wheels. Because of this, the connection of the connection terminals is automatically released. Further, the robot 100 leaves the station 200.

After the robot 100 leaves, the drive control unit 290 returns the table 202 to the initial position (refer to FIG. 6B) by causing the table 202 to rotate 180 degrees. Because of this, the next charging request can be promptly responded to.

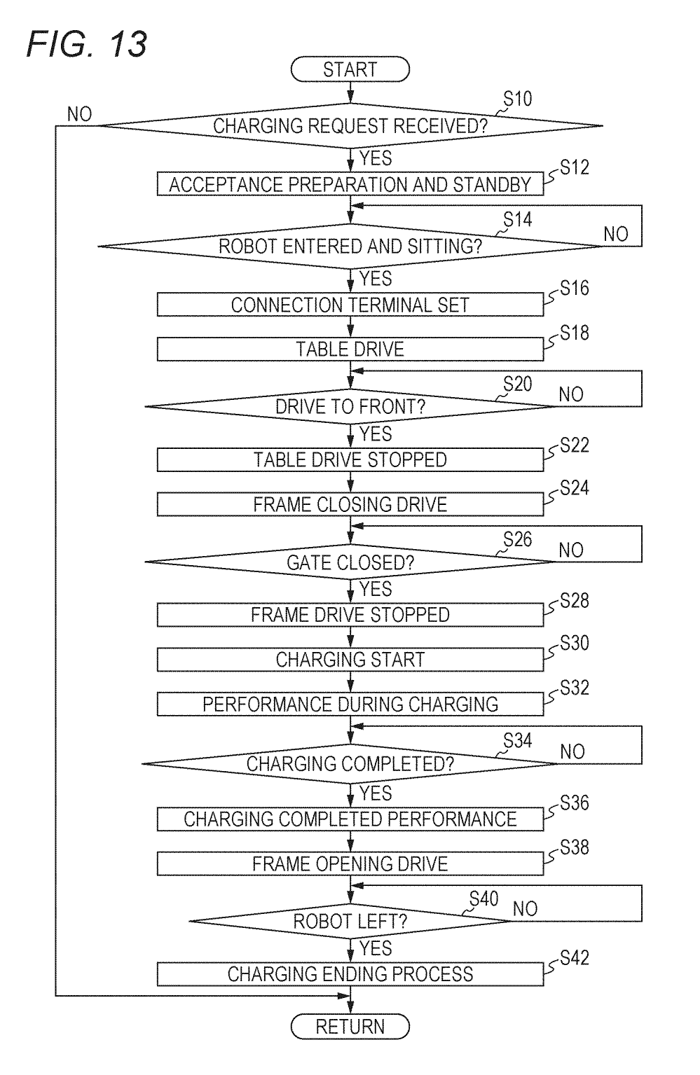

FIG. 13 is a flowchart showing an example of an operation control of the station 200.

A process in this drawing is executed repeatedly in a predetermined control cycle. When receiving a charging request signal from the robot 100 (Y of S10), the data processing unit 254 prepares to accept the charging request, and stands by (S12). For example, the data processing unit 254 starts an output of the heretofore described guiding signal, and a monitoring using the camera 262.

When the robot 100 enters the station 200 and sits on the table 202 (Y of S14), the drive control unit 290 causes the connection terminal 222 to protrude, and connect to the robot 100 (S16). Also, the drive control unit 290 causes the table 202 to rotate (S18). When the robot 100 is rotated to a position facing the front (Y of S20), the drive control unit 290 causes the rotation of the table 202 to stop (S22).

Continuing, the drive control unit 290 drives the frame 206 (the left support column unit 228 and the right support column unit 232) in directions such that the gate closes (S24). When the gate closes (Y of S26), the drive control unit 290 stops the drive of the frame 206 (S28), the charging control unit 292 starts a charging process, and the performance control unit 294 starts the heretofore described “performance during charging” (S32).

Further, when charging is completed (Y of S34), the performance control unit 294 starts the heretofore described “charging completed performance” (S36), and the drive control unit 290 drives the frame 206 (the left support column unit 228 and the right support column unit 232) in directions such that the gate opens (S38). Subsequently, when the robot 100 leaves the station 200 (Y of S40), a charging ending process of returning the table 202 to the initial position, and the like, is executed as heretofore described (S42). When no charging request is received (N of S10), the processes of S12 to S42 are skipped, and the whole process is ended once.

Heretofore, the robot 100, the station 200, and the charging system 10 including the robot 100 and the station 200 have been described based on the embodiment. According to the station 200, the frame 206 (wall member) disposed so as to enclose the perimeter of the table 202 is movable, and the gate through which the robot 100 enters and leaves can be opened and closed. Because of this, the robot 100 being charged can be protected from the exterior by closing the gate, while an exit (autonomous behavior) of the robot 100 can be carried out smoothly by opening the gate after charging.

Also, even when the gate is closed during charging, the face of the robot 100 can be exposed by one portion of the gate being an open space, and a special performance that is only seen during charging can also be carried out. In particular, when the robot 100 is of specifications that provide an animal-like presence like that of a pet, there is a possibility that although this presence may be achievable through normal autonomous behavior, a charging action, which is not animal-like behavior, will cause a user to lose interest. According to the embodiment, the robot 100 can be made to appear to be returning to the nest and resting, without causing a user to be aware of the charging action, by causing the gate to operate in a closing direction during charging. Because of this, there is an excellent affinity with specifications that provide an animal-like presence. Furthermore, by carrying out a special performance, a user can be caused to have a sensation that the robot 100 is near at hand, even during charging.

When the station 200 is of a size that can accept only one robot 100, the robot 100 can easily be caused to enter and leave through the gate by providing the table 202 with a rotation mechanism. In particular, even in the case of the heretofore described configuration wherein the perimeter of the table 202 is enclosed by the decorative member 210 and there is an open space in only a specific direction, an expression of the robot 100 can be seen through the hedge, because of which a user can be provided with a feeling of ease.

Furthermore, by the reference value providing unit 250 being provided in the station 200, the robot 100 can carry out calibration of the temperature sensor 406 (internal sensor) while being charged. That is, not only charging but also internal sensor maintenance can be carried out, because of which the usefulness of the station 200 is increased.

### Modified Example

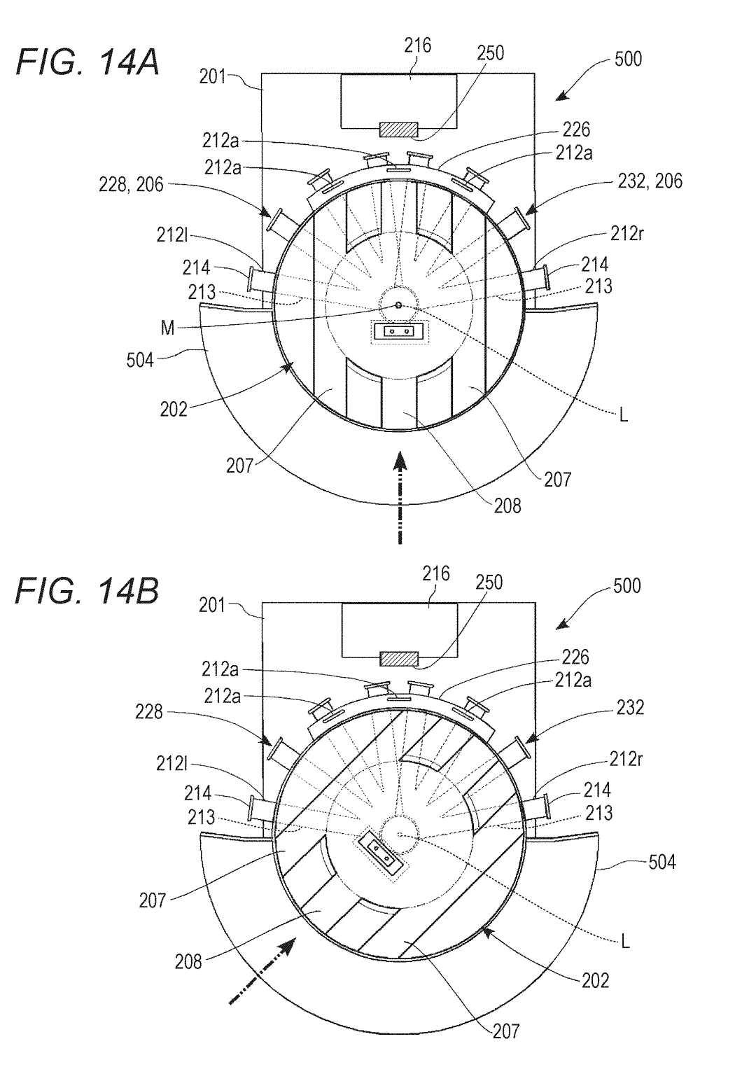

FIGS. 14A and 14B are drawings representing a configuration of a station 500 according to a modified example. FIG. 14A is a plan view representing a state wherein a decoration has been removed, and FIG. 14B is an illustration representing a drive mechanism.

In the embodiment, a configuration such that the position of the gate of the station 200 is limited, and the robot 100 can enter from only one direction, is shown as an example. In the modified example, a configuration such that the robot 100 can enter from many directions is employed.

As shown in FIG. 14A, the station 500 is such that a configuration of a slope 504 differs from that of the slope 204 of the embodiment. The slope 504 is provided over a wide angle range on the perimeter of the table 202. Because of this, the robot 100 can enter from the front, as shown in FIG. 14A, and can also enter from a diagonal direction (refer to a two-dot chain arrow), as shown in FIG. 14B. In the example shown in the drawings, the robot 100 can enter freely provided that the direction is within 30 degrees left or right with respect to the front direction.

The drive control unit 290 identifies a direction from which the robot 100 is approaching based on an image filmed by the camera 262, and adjusts a rotational position of the table 202 in accordance with the direction of approach. The drive control unit 290 controls the angle so that the front wheel 102 and the rear wheel 103 of the robot 100 can travel along the guide grooves 207 and 208 of the table 202, whatever direction the robot 100 approaches from. That is, the drive control unit 290 controls the angle of rotation of the table 202 so that the robot 100 is positioned on a straight line joining the mark M and the connection terminal 222. At this time, the robot 100 enters in such a way that the rotary shaft of the table 202 coincides with a line extended in the direction of travel. By causing the left and right front wheels 102 to rotate in opposing directions, the robot 100 can change the direction of travel on the spot, because of which the robot 100 can change the orientation, even immediately before riding up onto the slope 504, so that the direction of travel coincides with the rotary shaft of the table 202. Because of this, positions and angles of the connection terminals of the robot 100 and the station 500 can be caused to coincide. The mark M is provided in a position coinciding with the rotary shaft of the table 202 so that the robot 100 can recognize the rotary shaft.

Even when the robot 100 enters diagonally in this way, the drive control unit 290 has already ascertained the direction of entry. Because of this, the robot 100 can be oriented toward the front, and charging control and performance control can be carried out in the same way as in the embodiment. Depending on the configuration of the frame 206, a range of allowable entry angles of the robot 100 can also be increased.

The invention not being limited to the heretofore described embodiment and modified example, components can be modified and embodied without departing from the scope of the invention. Various inventions may be formed by combining a multiple of the components disclosed in the heretofore described embodiment and modified example as appropriate. Also, some components may be eliminated from the total of components shown in the heretofore described embodiment and modified example.

An example wherein the connection terminal 222 is provided in a position offset to one side from the center (central shaft L) of the table 202 is shown in the embodiment. In a modified example, a multiple of the connection terminal 222 may be provided, and selectively connected to the robot 100. Specifically, two connection terminals 222 may be provided in positions that are symmetrical in the center of the table 202. According to this kind of configuration, the process of returning the table 202 to the initial position by causing the table 202 to rotate 180 degrees every time the robot 100 is sent out can be omitted.

An example wherein the robot 100 carries out calibration when entering the station 200 for charging is shown in the embodiment. In a modified example, a configuration may be such that the reference value providing unit 250 is caused to function regardless of an existence or otherwise of charging, whereby calibration can be carried out. Also, a configuration may be such that calibration can be carried out even when the robot 100 exists outside the station 200. For example, calibration may be carried out by regularly detecting an output of the remote reference value providing unit 250 using the temperature sensor 406 (thermal imaging camera) of the robot 100.

An example wherein the reference value providing unit 250 is installed behind the frame 206 (on the side opposite the gate) is shown in the embodiment. In a modified example, the reference value providing unit 250 may be installed on the gate side. Because of this, calibration can also be carried out after charging of the robot 100 is completed, that is, after heat of the robot 100 itself has cooled to an extent. Because of this, calibration can be carried out with greater accuracy. In the embodiment, the target of calibration is a temperature sensor, but the target may also be another sensor, such as a form measuring sensor (depth sensor) or a posture sensor for detecting the posture of the robot.

An example wherein a guiding signal (infrared beam) is projected as means of guiding the robot 100 to the station 200 is shown in the embodiment, but other guiding means may also be employed. For example, a configuration may be such that a dedicated LED lamp is installed in the control device 216, and the robot 100 can identify a direction of entry by relying on light of the LED lamp. Alternatively, the station 200 may instruct (control) the robot 100 with regard to a direction of travel using wireless communication.

Wired charging by the station 200 is shown as an example in the embodiment. In a modified example, a wireless power supply method may be employed. An electromagnetic induction method, an electric field coupling method, a magnetic field resonance method, or the like, can be employed, but as each method is commonly known, a description thereof will be omitted.

Although not mentioned in the embodiment, the height of the frame 206 is preferably equal to or greater than the height of the robot 100. Because of this, the robot 100 can be completely housed by the station 200. This means that the robot 100 can reliably enter the station 200 regardless of where the station 200 is installed.

Although not mentioned in the embodiment, the decorative member 210 may be configured so as to be attachable to and detachable from the support column 212. By so doing, the decorative member may be replaceable in accordance with the size of the robot that is the charging target. A frame height necessary and sufficient for the height of the robot may be realized by changing the decorative member in accordance with the height of the robot. Also, a support column structure such that height is variable may be employed. Furthermore, a structure such that the support columns can be driven in a radial direction of the table, so that a diameter of an enclosure formed by the support columns is variable, may be employed. Owing to the size of the frame being variable in this way, the station is applicable to robots of various sizes and forms, and versatility of the station can be increased.

Although not mentioned in the embodiment, the performance control unit 294 may change the performance pattern in accordance with a personality or clothing of the robot 100. Alternatively, the performance control unit 294 may change the performance pattern in accordance with a time band.

Although not mentioned in the embodiment, a function of changing clothing of the robot may be incorporated in the station. Also, an air conditioning function, or a cooling function formed of a fan or the like, may be employed in the station, whereby heat of the entering robot is lowered. A cleaning function that removes dirt (dirt on the wheels or the like) on the robot may be incorporated in the station.

Although not mentioned in the modified example (FIGS. 14A and 14B) of the embodiment, a further mark (called a “mark N” for the sake of convenience) may be provided on the straight line joining the mark M and the connection terminal 222. The drive control unit 290 may control the angle of rotation of the table 202 so that the robot 100 is positioned on a straight line joining the mark M and the mark N. According to this kind of configuration, it is sufficient that the drive control unit 290 identifies the orientation of the table 202 by recognizing the marks M and N based on an image filmed by the camera 262, and there is no longer a need to recognize the connection terminal 222. Arranging so that the marks are set in an aspect (form, color, or the like) easily recognized by the robot 100 is particularly effective. In this case, the mark N is preferably provided in an end portion of the table 202, or the like, so that a distance of the mark N from the mark M is greater than that of the connection terminal 222. When the distance between the mark M and the connection terminal 222 is small, identifying the orientation of the table 202 using the two is difficult. In this kind of case too, identifying the orientation of the table 202 becomes easier, and controlling the angle of rotation of the table 202 becomes easier, by setting the distance (interval) between the mark M and the mark N to be large.

Furthermore, the drive control unit 290 may recognize the mark M and a central portion (called a “central portion R” for the sake of convenience) of the robot 100 based on an image filmed by the camera 262, and adjust the rotational position of the table 202 so that the mark M, the central portion R, and the mark N are aligned on a straight line. The central portion R may be a center of a front of the robot 100, and is preferably set so that the position of the front wheel 102 can be identified. The central portion R may be set on a central line of the robot 100 that is equidistant from the left wheel 102a and the right wheel 102b. In order to facilitate image processing, a marker may be provided on the central portion R, or a central portion of the robot 100 filmed by a camera may be utilized as a virtual marker.

What is claimed is:

1. A charging station comprising:
a table for supporting a robot;
a wall partially enclosing a perimeter of the table;
a charging terminal configured to provide power to the robot on the table;
a movement mechanism for causing a first portion of the wall to move along the perimeter of the table; and
a movement controller for controlling the movement mechanism.

2. The charging station according to claim 1, wherein the wall is configured to expose a face of the robot in a state where the wall surrounds the robot on the table.

3. The charging station according to claim 1, further comprising:
a rotation mechanism for causing the table to rotate; and
a rotation controller for controlling the rotation mechanism, wherein the rotation controller is configured to control the rotation mechanism to cause a face of the robot to be exposed by the wall while the robot is on the table.

4. The charging station according to claim 3, wherein
the table comprises an opening for exposing the charging terminal, and
the rotation controller is configured to rotate the table to align the opening with the charging terminal prior to the robot being on the table.

5. The charging station according to claim 4, wherein the opening is spaced from an axis of rotation of the table.

6. The charging station according to claim 1, wherein the charging terminal is configured to move in a direction parallel to an axis of rotation of the table.

7. The charging station according to claim 3, wherein
the rotation controller is configured to control a rotational position of the table in accordance with a direction from which the robot approaches.

8. The charging station according to claim 1, further comprising:
a calibration device configured to detect a parameter, and to output a signal to an internal sensor of the robot based on the detected parameter.

9. The charging station according to claim 1, further comprising:
a charge detector configured to detect whether charging of the robot is completed; and
a performance controller configured to execute a predetermined performance in response to the charging of the robot being complete.

10. The charging station according to claim 1, wherein the wall comprises a second portion, wherein the first portion is closer to the table in an axial direction than the second portion.

11. The charging station according to claim 10, wherein the first portion is stationary.

12. The charging station according to claim 10, the second portion is stationary.

13. The charging station according to claim 10, wherein the wall further comprises:
a first support column configured to support the first portion; and
a second support column configured to support the second portion.

14. The charging station according to claim 13, wherein the first support column is movable relative to the table.

15. The charging station according to claim 1, wherein the table further comprises a ramp.

16. A method of charging a robot comprising:
receiving the robot on a table;
moving at least a portion of a wall to surround the robot on the table;
rotating the table after receiving the robot; and
connecting a charging terminal to the robot after receiving the robot, wherein the connecting the charging terminal comprises connecting the charging terminal to the robot through an opening in the table.

17. The method according to claim 16, further comprising:
detecting whether charging of the robot is complete; and
disconnecting the charging terminal from the robot in response to the charging of the robot being complete.

18. The method according to claim 17, further comprising:
moving the at least the portion of the wall to expose the robot in response to the charging of the robot being complete.

19. The method according to claim 16, wherein the connecting of the charging terminal to the robot comprises moving the charging terminal in a direction parallel to an axis of rotation of the table.

20. A charging station comprising:
a table for supporting a robot;
a wall partially enclosing a perimeter of the table;
a charging terminal configured to provide power to the robot on the table;
a movement mechanism for causing a first portion of the wall to move along the perimeter of the table; and
a controller for controlling the movement mechanism, wherein the controller is further configured to detect whether a posture of the robot satisfies a predetermined condition, and the controller is configured to connect the charging terminal to the robot in response to the posture of the robot satisfying the predetermined condition.
